(19) United States
(12) Patent Application Publication
(10) Pub. No.: US 2014/0074505 A1
(43) Pub. Date: Mar. 13, 2014

(54) SYSTEM AND METHOD FOR MANAGING THE DISTRIBUTION OF MEDICATION TO PATIENTS

(71) Applicant: Daire Scanlon, Limerick (IE)

(72) Inventor: Daire Scanlon, Limerick (IE)

(21) Appl. No.: 13/610,582

(22) Filed: Sep. 11, 2012

(51) Int. Cl. G06F 19/00; G06Q 50/22

(52) U.S. Cl. CPC G06F 19/3456; G06Q 50/22
USPC 705/3; 705/2

(57) ABSTRACT

A system for managing the distribution of medication to patients. The system comprises a point of care (POC) device which is configured for creating digital medical prescriptions for individual patients. A data repository is provided which is associated with the POC device and is operable for storing the digital medical prescriptions. A computer is provided which is in communication with the data repository and is operable for retrieving the digital medical prescriptions therefrom. The computer is configured to generate respective labels containing at least one identifier that associates a medication of a digital medical prescription to a particular patient.

### FIELD OF THE INVENTION

The present invention relates to a system and method for managing the distribution of medication to patients. In particular, the invention relates to a process for prescribing medication to patients.

### BACKGROUND

Medication dispensing errors in care facilities cause significant delays and costs in administrating medication to patients. If patients are given medication which differs to what was actually prescribed for them by a medical practitioner then this may pose a serious risk to patient's health. Hospitals and other care facilities are often challenged to increase the accuracy and turn-around time of medical prescriptions. This problem is exacerbated where the dispensary tasked with dispensing medication is located remotely from a care institution. Attempts have been made to address this problem by providing on site dispensaries rather than relying on remote dispensaries. The cost of providing on site dispensaries is significant and may be uneconomical for some care facilities.

US20020035484 discloses a system and method of generating a medication prescription. This disclosure describes a system where a physician uses a handheld terminal to tap and select a prescription where the terminal has information that is useful to the physician. This includes GPS location information designed to verify that the physician is licensed in the state where the prescription is being made.

US20120035957 discloses a system that delivers relevant information to a prescriber at the time of entering a prescription in an electronic prescription management system.

US7630789 discloses a system and apparatus for the dispensing of drugs where a medication cart contains modules which may be controlled by a computer system.

US7698019 discloses a system and software of enhanced pharmaceutical operations in long-term care facilities. Each facility has a pharmacy server in communication with medication carts and in addition there is a remote pharmacy management server which is in communication with the remote pharmacy server.

US7058584 discloses an apparatus and method for processing prescription requests using a remotely located prescription management system. In this system a prescription request is transmitted to a remote pharmacist who completes a prescription form for fulfillment by a pharmacy.

The problems associated with the identified prior art are as follows. There is a need for care facilities to invest in trolley technology in order to provide verification and audits. Some of the prior art requires manual steps for prescription processing in the pharmacy which may result in human error. Many of the prior art disclosures require dedicated information technology infrastructure at multiple locations.

There is therefore a need for a system and method for managing the distribution of medication to patients which addresses at least some of the drawbacks of the prior art.

### SUMMARY

These and other problems are addressed by provision of a system and method in accordance with the present teaching.

Accordingly, a first embodiment provides a system for managing the distribution of medication to patients. The system comprises a point of care (POC) device configured for creating digital medical prescriptions for individual patients; a data repository associated with the POC device operable for storing the digital medical prescriptions, a computer in communication with the data repository and operable for retrieving the digital medical prescriptions therefrom, wherein the computer is configured to generate respective labels containing at least one identifier that associates a medication of a digital medical prescription with a particular patient. Additionally, the present teaching provides a method for managing the distribution of medication to patients. The method comprises creating digital medical prescriptions for individual patients on a point of care (POC) device; storing the digital medical prescriptions and the particulars of corresponding patients in a data repository; retrieving, with a computing means, the digital medical prescriptions and the particulars of the associated individual patients from the data repository; and generating respective labels containing at least one identifier that associates a medication of a digital prescription to a particular patient. The teaching also relates to a point of care (POC) device configured to access a data repository storing a plurality of patient records detailing prescribed medication for individual patients. The POC device comprises a receiving module for receiving patient data and medication data associated with an individual patient co-located with the device; and a processor configured to cross reference the received patient data and medication data against the patient records stored in the data repository to validate the provision of medication to that individual patient. Advantageous embodiments are provided in the dependent claims.

These and other features will be better understood with reference to the following Figures which are provided to assist in an understanding of the present teaching.

### BRIEF DESCRIPTION OF THE DRAWINGS

The present teaching will now be described with reference to the accompanying drawings in which:

FIG. 1 is a block diagram of a system for managing the distribution of medication to patients in accordance with the present teaching.

FIG. 2 is a diagrammatic illustration of a point of care (POC) device of the system of FIG. 1.

FIG. 3 is a block diagram of the POC device of FIG. 2.

FIG. 4 is a screen shot of a graphical user interface displayed on the POC device of FIG. 2.

FIG. 5 is a screen shot of a graphical user interface displayed on the POC device of FIG. 2.

FIG. 6 is another screen shot of a graphical user interface displayed on the POC device of FIG. 2.

FIG. 7 is another screen shot of a graphical user interface displayed on the POC device of FIG. 2.

FIG. 8 is a diagrammatic illustration of a ward in a care facility where the system of FIG. 1 may be utilised.

### DETAILED DESCRIPTION

The application will now be described with reference to an exemplary system for managing the distribution of medication to patients which is provided to assist in an understanding of the present teaching.

The present teaching provides an integrated medication management system that provides a way of communicating prescriptions to medical dispensaries for automatic fulfillment and delivery. A prescription is an instruction written by a medical practitioner that authorizes a patient to be issued with a medicine. The medication which is to be issued to the patient is prepared in the medical dispensary by a pharmacist or the like who is professionally qualified to prepare and dispense medication. The present system allows carer facilities such as hospitals to use offsite medical dispensaries by linking them with a common system for medication management and delivery. The system allows hospitals to increase efficiency and reduce errors when administering medication by providing verification and audits.

Referring to the drawings there is provided a system 100 for managing the distribution of medication to patients. The system comprises a point of care (POC) device 105 configured for creating digital medical prescriptions for individual patients. The POC device 105 is configured to access one or more data repositories 110, 122 storing a plurality of patient records. The POC device 105 includes a receiving module for receiving patient data and medication data associated with an individual patient co-located with the device. The POC device 105 is operable to cross reference the received patient data and medication data against the patient records stored in the data repository 110 and/or data repository 122 to validate the provision of medication to that individual in order to determine that the correct medication is being administered.

The digital medical prescriptions are electronically written on the POC device 105. A data repository 110 is accessed by the POC device 105 for storing the digital medical prescriptions and patient data. The patient data may include particulars of corresponding patients such as a patient identifier 102 and/or biographic data which may be used to identify the patient. The digital medical prescriptions are stored on the data repository as medical data which may include a medication identifier 103 which may be used to identify medication which has been prescribed by a medical practitioner for a particular patient. The patient identifier 102 and a medication identifier 103 are cross referenced in the data repository 110 so that the prescribed medication is linked to a particular patient. An executable software module 108 resides on the POC device 105 which provides a graphical user interface 109 on a display/screen 111 of the POC device 105 which allows a medical practitioner to interact with the POC device 105 when prescribing medication.

When patients are being admitted to hospitals or care facilities, the admissions department assigns the patient identifier 102 to each admitted patient so that the patients are identifiable. The admissions department typically has a client device 140 for entering the particulars of patients into a central data repository 122 residing on a central server 120 using a web interface or the like. The patient's particulars may include biographic data such as the patient's name, address, age, sex, blood type, previous medical history etc. A central software application 142 residing on the central server 120 is configured to generate the patient identifier 102. In the exemplary embodiment, the patient identifier 102 is a machine readable identifier such as a barcode or the like. The patient identifier 102 may include a suitable indication which may be provided as a graphic and/or a piece of information which is associated with a particular patient. The piece of information may be textual and/or numerical or the like.

The client device 140 is operable to receive the patient identifier 102 from the central server 120 and an admissions software module 150 of the client device 140 generates a tag which is printed on a suitable medium such as a wrist band or the like. The patient is then tagged with the patient identifier 102 by securely fastening the wrist band around the patient's wrist. Typically, the wrist band may only be removed from the patient's wrist by cutting the wrist band with an implement such as a scissors thereby opening the closed loop band of the wrist band.

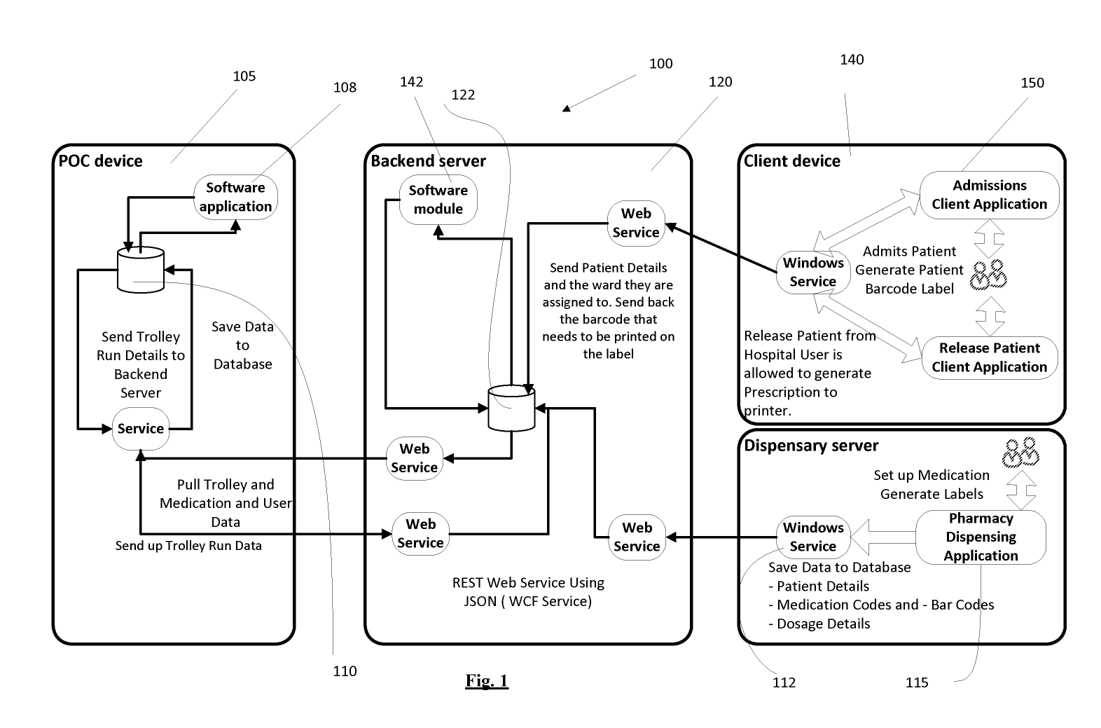

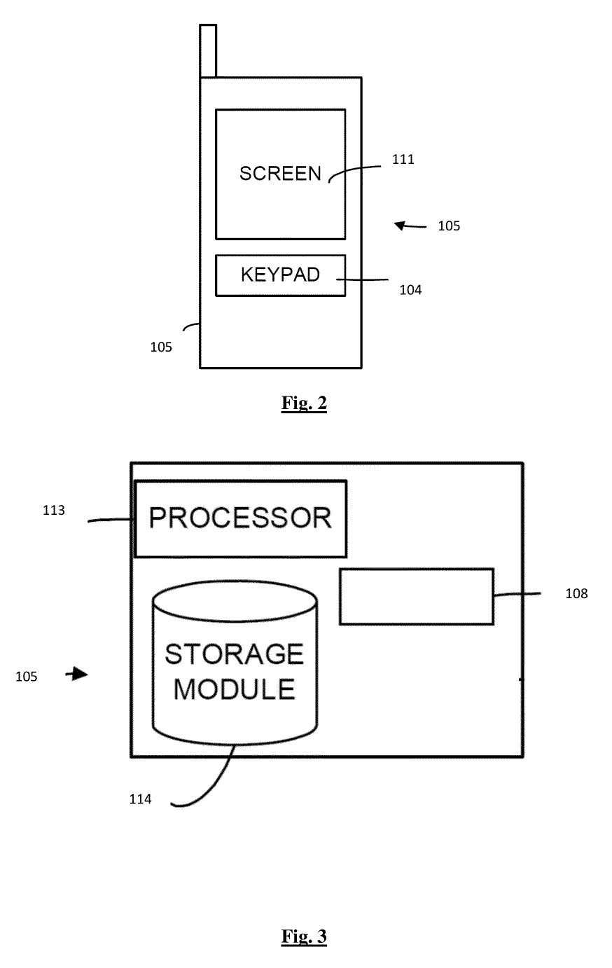

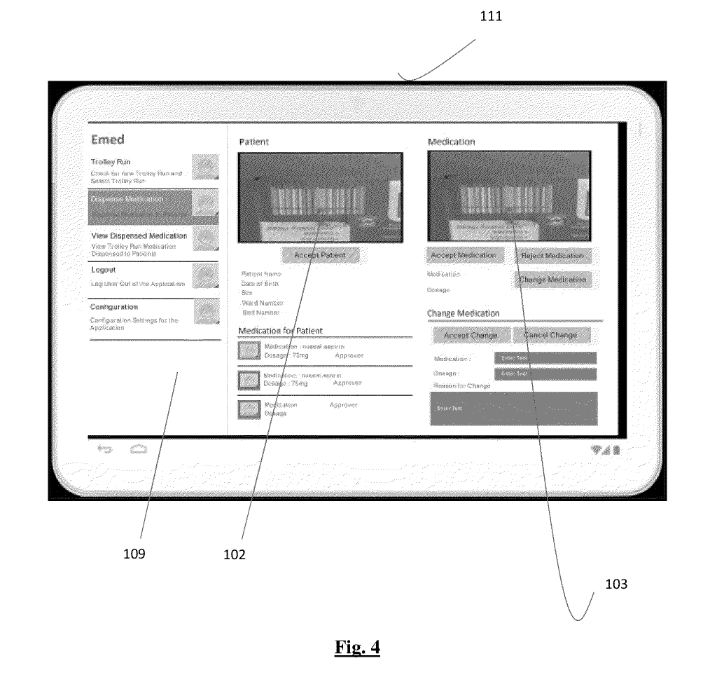

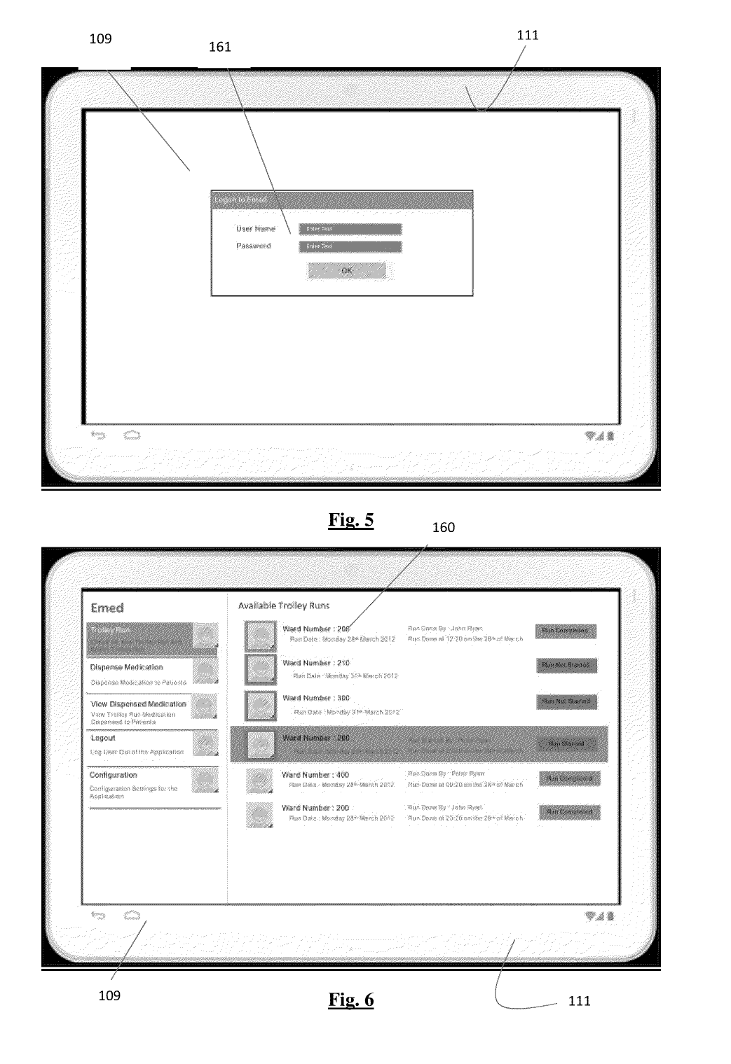

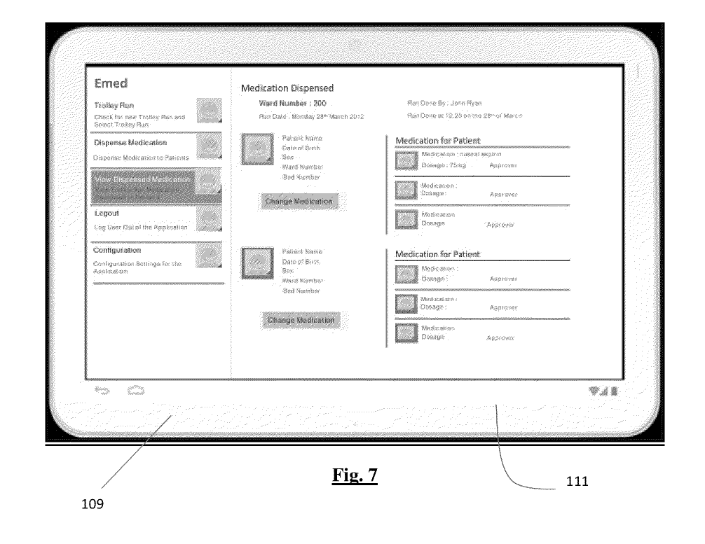

The contents of the central data repository 122 and the local data repository 110 residing on the POC device 105 are synchronised ether in real time or intermittently. This does not require a continuous or synchronous link between the POC device 105 and the central server 120, in that the information can be transferred between the POC device 105 and the central server 120 during times of connectivity and does not require an always up link between the two. In this way, the system 100 may operate in environments where only intermittent communication between the central server 120 and POC device 105 is possible. For example, in certain areas of a hospital which have sensitive medical equipment it may be undesirable for the POC device 105 to operate in a transmitting mode as the accuracy of the medical equipment may be affected. In this scenario, the POC device 105 may be operated in a non-transmitting mode which suspends transmitting functionality similar to an airplane mode available on most smart phones. The system of FIG. 1 may use conventional technology such as that provided by wireless platforms. The contents of data repository 110 may be communicated to the central server over a wireless network using GPRS or 3 G protocols or the like. It will be appreciated by those skilled in the art that while the exemplary embodiment includes a local data repository 110 residing on the POC device 105 and a central data repository 122 residing on the central server 120 it is not intended to limit the present teaching to this arrangement as alternative storage arrangements are possible which may use one or more data repositories over a suitable network as known in cloud computing.

A dispensary server 112 associated with a medical dispensary/pharmacy is operable for retrieving the patient identifier 102 and the medication identifier 103 from the central data repository 122. An executable software module 115 is provided on the dispensary server 112 which is configured for generating a digital label containing both the retrieved patient identifier 102 and the retrieved medication identifier 103. The digital label may be printed on a physical medium such as a paper label using a printer or a labelling machine. The label is then fixed to the packaging of the dispensed medication corresponding to that prescribed by the medical practitioner using the POC device 105. The labelled medication is then delivered to the hospital for administering to the particular patient corresponding to the patient identifier 102. Thus the prescribed medication and the corresponding patient are linked together to ensure that the correct medication is administered.

The POC device 105 may be configured to receive the patient identifier 102 by either electronically reading the patient identifier on the patient's wrist band or alternatively the patient identifier may be manually entered to the POC device 105 using a keypad or the like. In the exemplary embodiment, the POC device 105 is configured to electronically read the patient's identifier on the wrist band utilising a camera inbuilt on the POC device. Thus the camera provides a digital image capture module. The camera captures a digital image of the patient identifier 102, in this example, a barcode. The executable software module 108 is operable to read the barcode from the captured image and cross reference the barcode with the patient identifier in the data repository 110. Similarly, the POC device 105 is operable to capture a digital image of the patient identifier 102 and the medication identifier 103 on the label fixed to the medication which is to be administered to the patient. The executable software module 108 cross references the identifiers contained on the label of the medication with the patient identifier encoded in the barcode on the patient's wrist band. In one embodiment, the executable software module 108 is operable to perform optical character recognition on the captured digital images and generates text from the captured images which is cross reference against text contained in patient records stored in the data repositories 110, 122. Thus the POC device may be configured to optically read machine readable representations such as barcodes. It is not intended to limit the present teaching to barcodes as alternative data representations may be employed. It will be appreciated by those skilled in the art that prior to the medication being administered to the patient, the patient identifier on the label of the medication fixed thereto by the remote medical dispensary, must match the patient identifier contained on the wrist band of the patient. The risk that incorrect medication is administered to a patient is thereby significantly reduced.

The POC device 105 may include such devices as personal digital assistants (PDAs), smartphones or ultra mobile pc's (UMPC) such as those manufactured and provided by Sony Ericsson™, Nokia™, Samsung™, Blackberry™, TabletKiosk™ or the like. Further examples of the handheld devices include those that are dedicated for specific task such as those manufactured and provided by Psion™ or Hewlett Packard™. For the sake of convenience the POC device 105 is described as a smart mobile computing device, but it will be understood that this is purely exemplary of the type of device that could be used to implement the present teaching. The servers 112, 120 desirably include conventional computer architecture such as memory, processors, i/o devices and the like, as will be well appreciated by those skilled in the art. For the sake of clarity such conventional architecture components will be omitted from the following description. It will be further appreciated that while shown as a single entity the functionality of the central server 120 could be distributed over two or more individual machines. Internally within the POC device 105, is provided a processor 113 which is used to execute computer logic and a storage module 114 on which the data repository 110 is stored. The system 100 allows the capture of location information using a combination of GPS, Wifi, and telephone signals in order to provide an accurate location and time stamp log for all actions on the system.

The screen 111 of the POC device 105 is typically of the dimensions 320×240 pixels, but it will be understood that the screen size is not to be limited to such dimensions as it is for example known that screen sizes of up to 800×600 can be implemented within a handheld computing device environment. Such screen sizes are suitable for reading extended portions of text. To enable a user to interface with the device, a keypad 104 is typically provided. Depending on the features of the specific handheld device, this may include a QWERTY keypad, although the present teaching is not to be limited to devices having such keypads. For example, the user may also or alternatively interface with the device through use of a stylus or other interface device. Such alternative means of interfacing with a handheld device will be well understood by the person skilled in the art and it is not intended to limit the present invention to any one specific. For example, the POC device 105 may include a touch sensitive input screen or a voice activation module.

The POC device 105 may include at least one of a keyboard, scanner, microphone, touch screen, and code reader which provide a receiving module for inputting patient data and medication data. In an exemplary arrangement the receiving module includes a digital image capture module for capturing digital images of the patient data and medication data. The processor 113 may be configured to perform optical character recognition on the captured digital images. Furthermore, the processor is operable to generate text from the captured images and cross reference the generated text against text contained in the patient records stored in the data repository 110 or data repository 122.

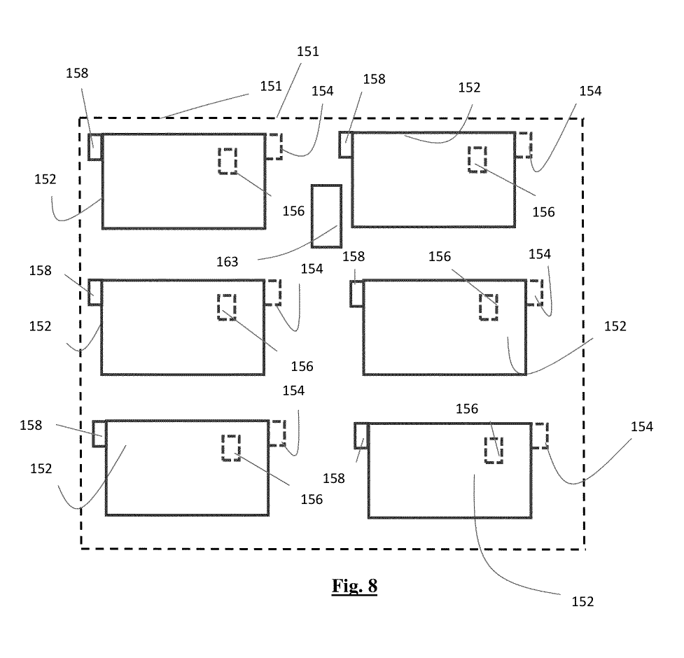

Referring now to FIG. 8, which illustrates a medical ward 151 of a hospital which includes six patient trolleys 152. Patient trolleys 152 are known in the art and typically comprise a frame carried on ground engaging wheels. The frame supports a mattress on which the patient lies. The frame may be adjustable in order to change the height of the mattress relative to ground. An adjustable head and/or foot portion may also be provided on the frame. In the present embodiment, a holder 154 is provided for holding the POC device 105. Furthermore, a battery 156 may be provided on the trolley 152 which is used to recharge the battery of the POC device 105. Alternatively, the battery 156 may be provided on a medicine trolley 163 which may be used to convey medication. The holder 154 may also be provided on the medicine trolley 163 if desired. It will be appreciated that a power point may not always be accessible in the vicinity of the trolleys 152, 163 and it is desirable to be able to charge the POC device 105 at either the patient trolley 152 and/or at the medicine trolley 163. The battery 156 may be electrically coupled to a power point 158 which may operably engage a main's electrical supply socket for charging the battery 156. Accordingly, the battery 156 may be a rechargeable battery. Alternatively, the battery 156 is releasably attached to the trolley so that it may be removed from the trolley and charged using an external battery charger. The holder 154 is configured for mating with the POC 105. In one arrangement, when the POC device 105 is operably engaged in the holder 154 the device 105 is electrically coupled to the battery for charging thereof.

The POC device 105 may also be coated with a coating/material to help prevent the spread of disease or bacteria, for example, a methicillin-resistant staphylococcus aureus (MRSA) resistant pharmaceutical coating may be applied to at least a portion of the device 105. Thus the POC device 105 may contain a pharmaceutical preparation so that it may be safely used in a medical environment such as in an operating theatre or the like.

Once the medication from the dispensary is delivered to the hospital it is loaded on the medicine trolley 163. The medicine trolley 163 typically has a number of compartments for holding the medication for the patients in each ward 151. A medical practitioner such as doctor or nurse may be tasked with administering the medication to the patients. Prior to administering the medication the practitioner using the POC device 105 scans the label on the medication provided by the dispensary which has both a patient identifier 102 and medication identifier 103. The practitioner also scans the identifier 102 on the patient's wrist band. The system 100 cross references the patient identifier 102 on the label and the patient identifier 102 on the wrist band. Also the system 100 cross references the medication identifier 103 against the medication identifier 103 associated with the patient identifier 102 in the data repository 110 and only if there is a match will the medication be administered to the patient by the practitioner. The procedure is repeated by the practitioner for each patient in the ward 151 as the medicine trolley 163 is moved along the ward between patient trollies 152. Thus the risk that incorrect medication is given to a patient is significantly reduced. Further, each ward may be assigned a unique ward identifier 160 and each medical practitioner may be assigned a unique practitioner identifier. The medical practitioner gains access to the system 100 by entering the unique practitioner identifier into a log in prompt 161 on the graphical user interface 109. On entry to a particular ward 151 the practitioner selects one of plurality of ward identifiers 160 on the GUI 109 and administers the medication to the patients listed on the GUI 109. Depending on the qualification or skill of the medical practitioner the practitioner may have limited rights to alter information in the system 100. For example, a doctor may be assigned access rights to the system 100 which allows the doctor to change a type of medicine or medicine dosage. A nurse may be assigned access rights preventing the nurse for editing medicine types or dosages. When the POC device 105 scans the patient identifier 102 on the patient's wrist band the particulars of the patient stored in the data repository 110 are retrieved and displayed on the screen 111.

In one exemplary arrangement, the system comprises a plurality of POC devices 105. In this arrangement, a first type of POC device 105 is configured for creating digital medical prescriptions for individual patients. The first type of POC device 105 is typically carried by a doctor who is professionally qualified to prescribe medication to patients. A second type of POC device is also provided which is typically carried by nurses when they are administering medication to patients. The second type of POC device is configured to access a data repository storing a plurality of patient records detailing prescribed medication for individual patients. The second type of POC device comprises a receiving module for receiving patient data and medication data associated with an individual patient co-located with the device. A processor is provided on the second type of POC device 105 which is configured to cross reference the received patient data and medication data against the patient records stored in the data repository to validate the provision of medication to that individual in order to determine that the correct medication is being administered. The receiving module of the second type of POC device may include at least one of a keyboard, scanner, microphone, touch screen, and code reader. In one example, the receiving module includes a digital image capture module for capturing digital images of the patient data and medication data. The processor may be configured to perform optical character recognition on the captured digital images. The processor may be operable to generate text from the captured images and cross reference the generated text against text contained in the patient records stored in the data repository.

It will be understood that what has been described herein is an exemplary method and system. While the present application has been described with reference to exemplary arrangements it will be understood that it is not intended to limit the teaching of the present application to such arrangements as modifications can be made without departing from the spirit and scope of the application.

It will be understood that while exemplary features of a system and methodology in accordance with the teaching of the invention have been described that such an arrangement is not to be construed as limiting the invention to such features. A method of and a system for managing medication in accordance with the present teaching can be implemented in software, firmware, hardware, or a combination thereof. In one mode, a method of and a system for managing medication is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. Therefore, the servers or POC device as described with reference to FIG. 1 may be considered as representative of any computer(s) in which the method of and a system for managing medication resides or partially resides. The server or POC device may include one or more processors and may include a distributed architecture with multiple nodes. It will be appreciated that the claimed system may be implemented on a cloud computing platform having a distributed network of nodes. The nodes may include one or more processing units as will be appreciated by those of ordinary skill in the art.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the steps of the method for managing the distribution of medication to patients. The processor(s) is a hardware device for executing software, particularly software stored in memory. Processor(s) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor, Inc. POC device 105 may also represent a distributed processing architecture such as, but not limited to, SQL, Smalltalk, APL, KLisp, Developer 200, Erlang, Scala, Hadoop, BigTable, Amazon EC2, Microsoft Azure, NoSQL databases and Cloud Computing. It will be appreciated that the system may implemented on a distributed processing architecture.

Memory is associated with processor(s) and is operable to receive data. Memory can include any one or a combination of volatile memory elements (e.g., random access memory (RAM, such as DRAM, SRAM, SDRAM, etc.) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions of the distribution method. In the example of heretofore described, the software in memory includes the one or more components of the method of and a system for managing the distribution of medication to patients and is executable on a suitable operating system (O/S). A non-exhaustive list of examples of suitable commercially available operating systems is as follows: (a) a Windows operating system available from Microsoft Corporation; (b) an Apple iOS available from Apple Computer, Inc; (c) a Macintosh operating system available from Apple Computer, Inc.; (d) a UNIX operating system, which is available for purchase from many vendors, such as the Hewlett-Packard Company, Oracle Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g. Apple iOS, Android, Roku). The operating system essentially controls the execution of other computer programs, such as that provided by the present teaching, and provides scheduling, input-output control, file and data management, memory management, and communication control and related services.

The system 100 provided in accordance with the present teaching may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

The I/O devices and components of the POC device 105 may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices may also include output devices, for example but not limited to, output modules for PLCs, a printer, bar code printers, displays, etc. Finally, the I/O devices may further include devices that communicate both inputs and outputs, for instance but not limited to, a modulator/demodulator (modem; for accessing another device, system, or network), a radio frequency (RF) or other transceiver, a telephonic interface, a bridge, and a router.

When the method of and the system for managing the distribution of medication is implemented in software, it should be noted that such software can be stored on any computer readable medium for use by or in connection with any computer related system or method. In the context of this document, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), Digital Video Disc (DVD), Universal Serial Bus (USB) and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

Any method steps should be understood as representing modules, segments, or portions of code which include one or more executable instructions for implementing specific logical functions or steps in the method, and alternate implementations are included within the scope of the embodiments of the present teaching in which functions may be executed out of order from that shown or discussed, including substantially concurrently or in reverse order, depending on the functionality involved, as would be understood by those having ordinary skill in the art.

It should be emphasized that the above-described embodiments of the present teaching, particularly, any “preferred” embodiments, are possible examples of implementations, merely set forth for a clear understanding of the principles. Many variations and modifications may be made to the above-described embodiment(s) without substantially departing from the spirit and principles of the invention. All such modifications are intended to be included herein within the scope of this disclosure and the present invention and protected by the following claims.

Although certain example methods, apparatus, systems and articles of manufacture have been described herein, the scope of coverage of this application is not limited thereto. On the contrary, this application covers all methods, systems, apparatus and articles of manufacture fairly falling within the scope of the appended claims.

The advantages of the present teaching are many. The present teaching may be used to implement verification and audit processes using software taking advantage of barcode technology, digital photography and location identification technology. Additionally, the present teaching does not require manual intervention to create a prescription in a pharmacy. The present system may be implemented using cloud computing technology or the like. Also the system provides high resolution location based information using at least one of GPS, WiFi and telecommunication signals.

The words comprises/comprising when used in this specification are to specify the presence of stated features, integers, steps or components but does not preclude the presence or addition of one or more other features, integers, steps, components or groups thereof.

What is claimed is:

1. A system for managing the distribution of medication to patients, the system comprising:
a point of care (POC) device configured for creating digital medical prescriptions for individual patients;
a data repository associated with the POC device operable for storing the digital medical prescriptions,
a computer in communication with the data repository and operable for retrieving the digital medical prescriptions therefrom, wherein the computer is configured to generate respective labels containing at least one identifier that associates a medication of a digital medical prescription with a particular patient.

2. The system as claimed in claim 1, wherein the at least one identifier comprises a patient identifier and a medication identifier.

3. The system as claimed in claim 1, wherein the at least one identifier comprises an indication which includes at least one of a graphic and a piece of information.

4. The system as claimed in claim 1, wherein the at least one identifier comprises a machine readable code.

5. The system as claimed in claim 4, wherein the machine readable code comprises a barcode.

6. The system as claimed in claim 1, wherein the POC device is a portable handheld device.

7. The system as claimed in claim 1, wherein the data repository is provided locally on the POC device.

8. The system as claimed in claim 1, wherein the data repository includes a local data repository and a central data repository.

9. The system as claimed in claim 8, wherein the local data repository and the central data repository are synchronised in real time.

10. The system as claimed in claim 8, wherein the local data repository and the central data repository are synchronised intermittently.

11. The system as claimed in claim 9, wherein the local data repository and the central data repository are synchronised across a network.

12. The system as claimed in claim 11, wherein the network comprises a wireless network.

13. The system as claimed in claim 12, wherein the network comprises a telephone network.

14. The system as claimed in claim 8, wherein the local data repository resides on the POC device and the central data repository resides on a central server.

15. The system as claimed in claim 14, wherein the central server is located remotely from the POC device.

16. The system as claimed in claim 1, wherein the POC device includes a graphical user interface for facilitating creating the medical prescriptions thereon.

17. The system as claimed in claim 8, further comprising a client device operable for communicating patient particulars to the central data repository for storing thereon.

18. The system as claimed in claim 1, further comprising a trolley.

19. The system as claimed in claim 18, wherein the trolley includes a holder for receiving the POC device.

20. The system as claimed in claim 18, wherein the trolley includes a battery for powering the POC device.

21. The system as claimed in claim 20, wherein the battery is rechargeable.

22. The system as claimed in claim 1, wherein the POC device comprises a pharmaceutical preparation.

23. The system as claimed in claim 22 wherein at least a portion of the POC device is coated with a pharmaceutical coating.

24. The system as claimed in claim 1, wherein the POC device includes a camera for capturing digital images of the at least one identifier.

25. The system as claimed in claim 1, wherein the POC device includes a camera for capturing digital images of a plurality of identifiers.

26. The system as claimed in claim 24, wherein the POC device is configured for reading a patient identifier from the captured image.

27. The system as claimed in claim 26, wherein the POC device is configured for cross referencing the read patient identifier with a digital medical prescription and the particulars of a corresponding patient stored in the data repository.

28. The system as claimed in claim 1, further comprising a printer for printing the respective labels.

29. The system as claimed in claim 1 operable to capture location information to provide a location and time stamp log for all actions on the system.

30. The system as claimed in claim 1, further comprising a second POC device configured to access a data repository storing a plurality of patient records detailing prescribed medication for individual patients.

31. The system as claimed in claim 30, wherein the second POC device comprises:
a receiving module for receiving patient data and medication data associated with an individual patient co-located with the device; and
a processor configured to cross reference the received patient data and medication data against the patient records stored in the data repository to validate the provision of medication to that individual patient.

32. A method for managing the distribution of medication to patients, the method comprising,
creating digital medical prescriptions for individual patients on a point of care (POC) device;
storing the digital medical prescriptions and the particulars of corresponding patients in a data repository;
retrieving, with a computing means, the digital medical prescriptions and the particulars of the associated individual patients from the data repository; and
generating respective labels containing at least one identifier that associates a medication of a digital prescription to a particular patient.

33. The method as claimed in claim 32, wherein the at least one identifier comprises a patient identifier and a medication identifier.

34. The method as claimed in claim 32, wherein the at least one identifier comprises an indication which includes at least one of a graphic and a piece of information.

35. The method as claimed in claim 32, wherein the at least one identifier comprises a machine readable code.

36. The method as claimed in claim 35, wherein the machine readable code comprises a barcode.

37. The method as claimed in claim 32, further comprising printing the respective labels.

38. The method as claimed in claim 37, further comprising fixing the respective labels to corresponding medication.

39. A point of care (POC) device configured to access a data repository storing a plurality of patient records detailing prescribed medication for individual patients; the POC device comprising:
a receiving module for receiving patient data and medication data associated with an individual patient co-located with the device; and
a processor configured to cross reference the received patient data and medication data against the patient records stored in the data repository to validate the provision of medication to that individual patient.

40. The POC device as claimed in claim 39; wherein the receiving module includes at least one of a keyboard, scanner, microphone, touch screen, and code reader.

41. The POC device as claimed in claim 39, wherein the receiving module includes a digital image capture module for capturing digital images of the patient data and medication data.

42. The POC device as claimed in claim 41, wherein the processor is configured to perform optical character recognition on the captured digital images.

43. The POC device as claimed in claim 42, wherein the processor is operable to generate text from the captured images and cross reference the generated text against text contained in the patient records stored in the data repository.

44. The POC device as claimed in claim 39, wherein the receiving module is configured for optically reading machine readable representations.

45. The POC device as claimed in claim 44, wherein the receiving module is operable for optically reading barcodes.

46. The POC device as claimed in claim 39, configured for mating with a holder mounted on a trolley.

47. The POC device as claimed in claim 39, further comprising a graphical user interface (GUI).

48. The POC device as claimed 47, wherein the GUI is password protected.

49. The POC device as claimed in claim 39, further comprising a battery.

50. The POC device as claimed in claim 39, wherein the data repository resides on the POC device.

51. The POC device as claimed in claim 39, wherein the data repository is located on a server remotely from the POC device.

52. The POC device as claimed in claim 51, configured for communicating with the server across a wireless network.
